(19) United States
(12) Patent Application Publication
(10) Pub. No.: US 2019/0373881 A1
(43) Pub. Date: Dec. 12, 2019

(54) PEST-PREVENTING BRACELET

(71) Applicant: Paul Herskovitz, Northbrook, IL (US)

(72) Inventor: Paul Herskovitz, Northbrook, IL (US)

(21) Appl. No.: 16/006,626

(22) Filed: Jun. 12, 2018

(51) Int. Cl. A01M 29/12; A44C 5/00; A01M 13/00

(52) U.S. Cl. CPC A01M 29/12; A01M 13/00; A44C 5/0007

(57) ABSTRACT

A device for repelling pests includes a strap securable to a person and a module. The module has a hollow housing containing a printed circuit board, a switch, and a transducer. A battery drawer and a repellant drawer are removably insertable into the hollow housing. A repellant element impregnated with a evaporating repellant is affixable to the repellant drawer. The transducer causes high frequency waves and movement of the repellant element with the body causes the repellant to disperse.

### FIELD OF THE INVENTION

The invention relates to pest protection. More specifically, the invention relates to wearable devices for warding off insects, such as mosquitos.

### BACKGROUND

While chemicals for application to the skin are well known for humans, and collars treated with such chemicals are well known for pets, such are rife with deficiencies, dangers, and complexities.

There exists a need, and it is an objective of the invention, to provide a more effective and more simple-to-use human-wearable device for warding off insects, such as mosquitos.

There also exists a need, and it is also an objective of the invention, to provide such a device that does not expose the user to harmful chemicals.

There also exists a need, and it is also an objective of the invention, to provide such a device that has battery operation and enables simple battery replacement.

There also exists a need, and it is also an objective of the invention, to provide such a device that employs movement of a human body to naturally dispense a pest preventative.

There also exists a need, and it is also an objective of the invention, to provide such a device that enables simple replacement of its preventative when exhausted.

Additional needs and objectives will become apparent by a review of the following disclosure.

### SUMMARY OF THE INVENTION

The invention may be embodied in or practiced using a device for repelling pests having a hollow housing with first and second vents, a printed circuit board disposed within the hollow housing and including a battery receiver, and a transducer disposed adjacent the first vents. A battery drawer may be removably insertable into the hollow housing. A battery may be removably affixable to the battery drawer such that when the battery drawer is inserted into the hollow housing the battery is in in electrical communication with the battery receiver and the transducer. A repellant drawer may be removably insertable into the hollow housing. A repellant element impregnated with a evaporative repellant may be removably affixable to the repellant drawer such that when the repellant drawer is inserted into the hollow housing the repellant element is adjacent the second vents. Energization of the transducer by the battery may cause the transducer to emit high frequency waves though the first vents and air currents cause the repellant to disperse through the second vents.

The device may include a fastener for securement to a person, wherein when the device is secured against the person and the repellant drawer is inserted into the housing, the repellant moves with the person and air currents caused thereby causes the repellant to disperse through the second vents. The fastener may be from the group including a strap, a clip, and a strap-clip combination. The energized transducer may emit high frequency waves at one or more frequencies from the group including 7.9 Khz, 12 Khz, 15 Khz, and 17 Khz.

A switch may be in electrical communication with the battery and the transducer, and may be adapted for energizing the transducer in a closed state and preserving the battery's life in an open state. The switch's closed state may include a plurality of frequency states for selecting the high frequency waves from the group including 7.9 Khz, 12 Khz, 15 Khz, and 17 Khz.

The repellant may include citronella. The battery receiver may include a spring, and the spring may secure the printed circuit board within the hollow housing.

The invention may alternatively be embodied in or practiced using a device for repelling pests and including a strap securable to a person, and a module. The module may be the device as described above.

The foregoing summary, as well as the following detailed description will be better understood when read in conjunction with the appended drawings. There are shown in the drawings an embodiment which is presently preferred. It should be understood, however, that the disclosure is not limited to the precise arrangements and instrumentalities shown.

### BRIEF DESCRIPTION OF THE DRAWINGS

The various objects, advantages and novel features of this invention will be more fully apparent from a reading of the following detailed description of an exemplary embodiment thereof, in conjunction with the accompanying drawings in which like reference numerals refer to like parts, and in which:

FIG. 1 is a view of a bracelet according one example of the invention being worn around a wrist;

FIG. 2 is a perspective view of the module of the bracelet of FIG. 1 with both of its drawers opened;

FIG. 3A is an exploded bottom view of the module of FIG. 2;

FIG. 3B is a top view of the PCB of the module of FIG. 3A;

FIG. 4 is a cross sectional view of the module of FIG. 2 taken at line 4-4 of FIG. 2;

FIG. 5 is a partial bottom cross-sectional view of the extended repellant drawer of the module of FIG. 2;

FIG. 6 is a partial bottom view of the extended repellant drawer of the module of FIG. 2;

FIG. 7 is a partial bottom cross-sectional view of the module of FIG. 2;

FIG. 8 is a cross-sectional view of the module of FIG. 2 taken at line 8-8 of FIG. 7; and

FIG. 9 is a cross-sectional view of the repellant drawer of the module of FIG. 2.

### DESCRIPTION OF AN EXEMPLARY EMBODIMENT

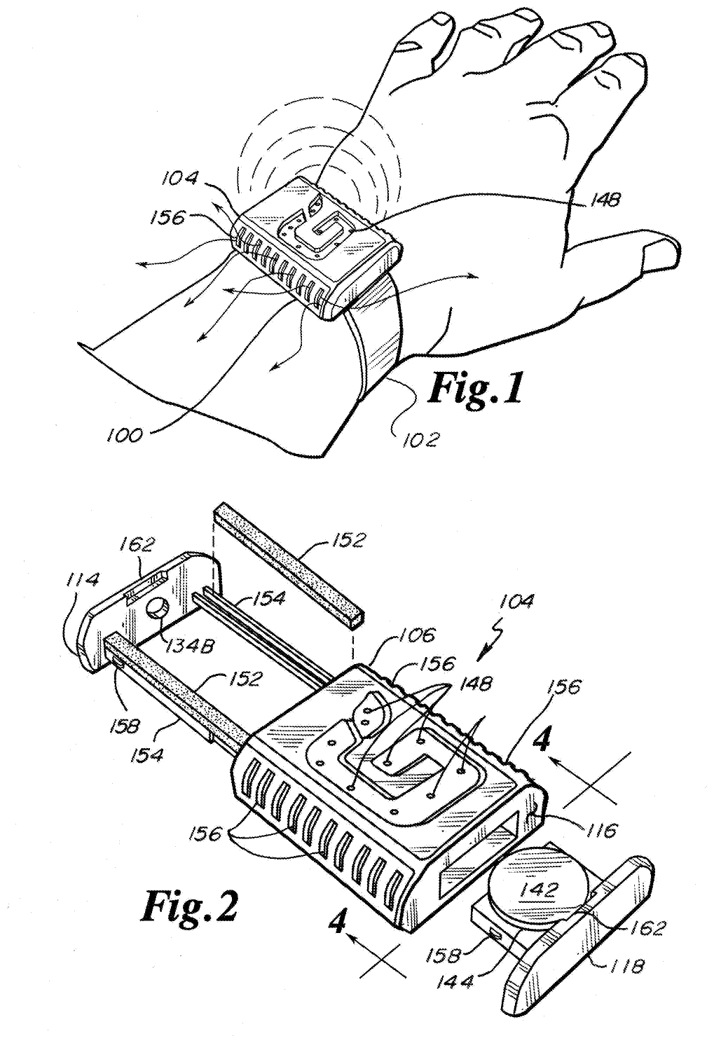

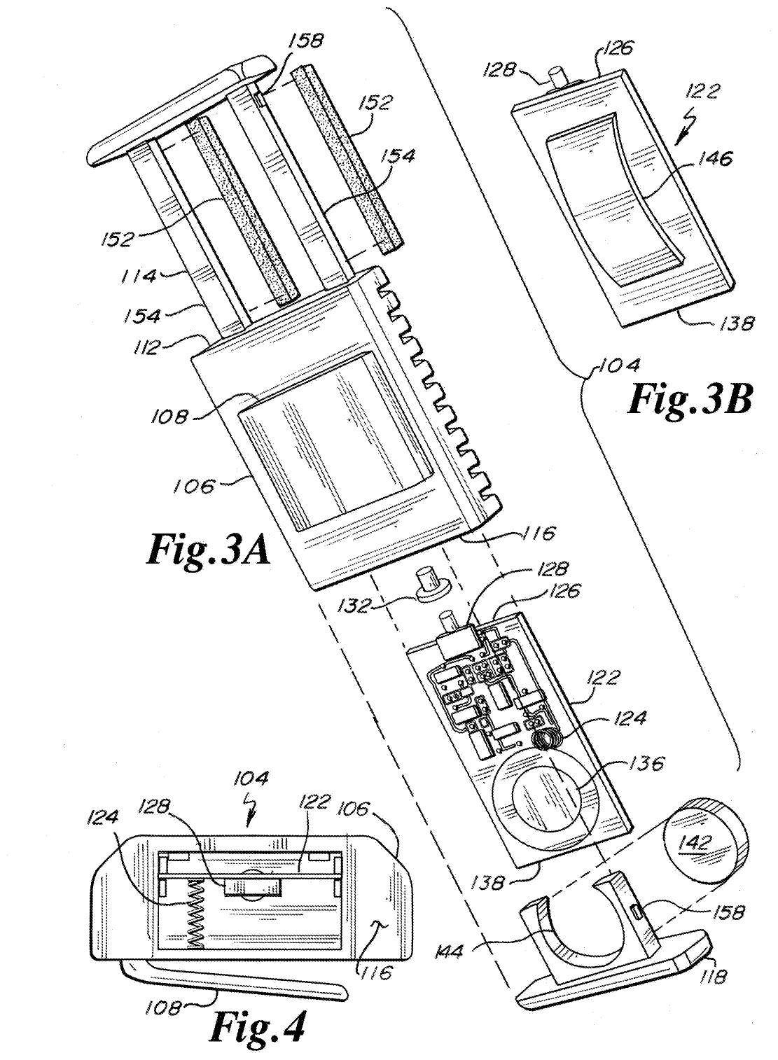

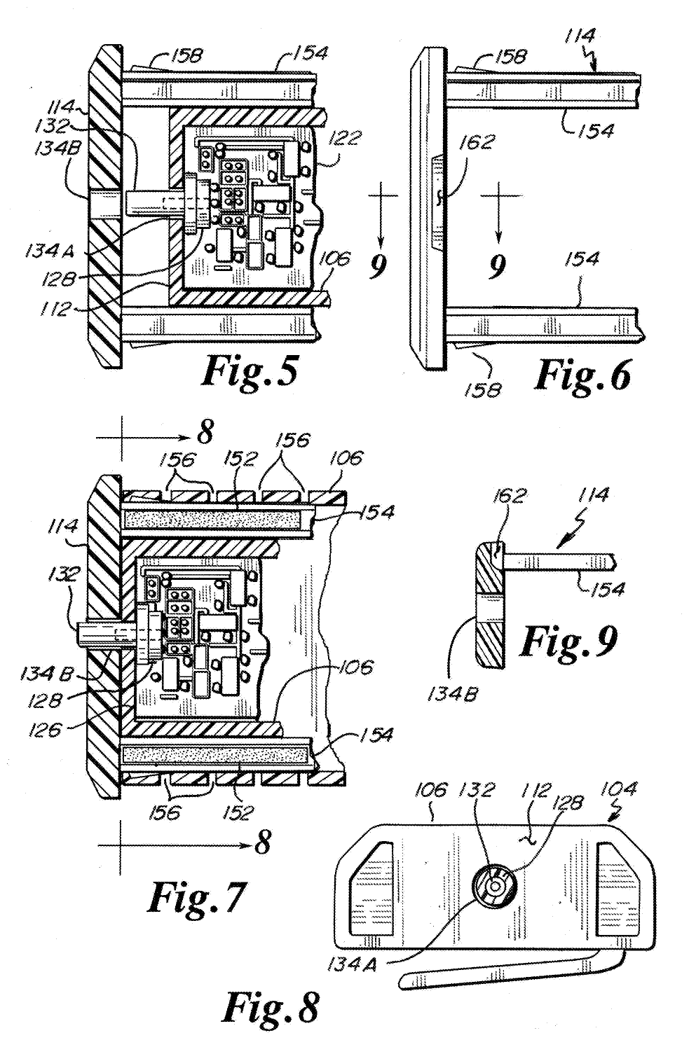

Referring to the Figures, a pest-repelling wrist strap assembly 100 is shown which includes a flexible wrist band 102 and a repellant module 104. The module is removably affixable to the band. The module includes main housing 106 and clip 108. The clip is adapted to interface with a clip receiver (not seen) of the band. As seen in FIG. 1, the preferably-elastomeric band is preferably wrapped around a wearer's wrist so that the strap assembly is worn like a wristwatch.

Preferably-plastic main housing 106 is hollow and has a closed repellant end 112 adapted to receive removable preferably-plastic repellant drawer 114 and an open battery end 116 adapted to receive removable preferably-plastic battery drawer 118, as best seen in FIG. 2. Within the hollow interior is disposed a printed circuit board (PCB) 122 which includes electronic circuitry and components. The PCB is slid into the housing through the open battery end and held there-within by the compressive force on its extension spring 124.

Switch 128 is disposed on the bottom surface of the PCB on its distal repellant edge 126 and is covered by preferably-plastic button 132 and together protrude loosely through switch hole 134A in the housing's repellant end and switch hole 134B of the repellant drawer so that button is accessible to the wearer at the repellant end to activate the switch.

Battery pad 136 is disposed on the bottom surface of the PCB adjacent its battery edge 138. The pad and spring 124 provide two electrical contacts for coin-type battery 142, preferably an LR 44 battery or equivalent, which fits first into battery holder 144 of the removed battery drawer and which makes contact with the pad and spring when the battery drawer is fully inserted into the battery end of the housing.

Transducer 146 is disposed on the top surface of the PCB such that it aligns with an array of holes 148 through the top surface of the main housing. Evaporating repellant strips 152 fit into channels 154 of the repellant drawer so that when the repellant drawer is fully inserted, the strips are disposed adjacent arrays of slots 156 on each side of the main housing.

Both the repellant and battery drawers include bosses 158 which engage mating depressions (not seen) within the interior of the housing so that a positive “clicking” action indicates full insertion and to secure the drawers to the housing absent sufficient removal force by the wearer. Fingernail depressions 162 in both drawers allow the wearer to gain leverage to provide sufficient removal force so that the drawers can be removed for replacement of the battery and repellant strips.

The repellant strips are impregnated with pest-repelling chemicals which evaporate as the strips become exposed to air currents, such as by movement of the person's body. Activation of the switch causes the transducer to vibrate and produce high frequency waves that repel pests such as mosquitos and other insects. The first push on the switch causes the transducer to vibrate at 7.9 Khz. Repeated activation of the switch cycles the vibration through frequencies of 12 Khz, 15 Khz, and 17 Khz, which each produce waves of that frequency to target different pests. A final activation of the switch opens the circuit and terminates the vibration to preserve battery life.

The strips are preferably made of EVA impregnated with all-natural chemicals including citronella and are replaceable when the chemicals are exhausted by temporary removal of the repellant drawer. The battery is replaceable when spent by temporary removal of the battery drawer.

While preferably worn on the wrist in conjunction with the band 102, clip 108 allows that module 104 may alternatively be secured to other places, such as a neck band, an ankle band, or even a shirt pocket. The module may even be used off-body so long as it is placed in an environment where it will experience air currents to enhance evaporation and dispersal of the repellant, or otherwise where vibration alone provide satisfactory repellence.

It should be understood that while the invention has been shown and described with reference to the specific exemplary embodiment shown, various changes in form and detail may be made without departing from the spirit and scope of the invention, and that the invention should therefore only be limited according to the following claims, including all equivalent interpretation to which they are entitled.

I claim:

1. A device for repelling pests, comprising:
a hollow housing having first and second vents;
a printed circuit board disposed within the hollow housing and comprising a battery receiver, a switch, and a transducer disposed adjacent the first vents;
a battery drawer removably insertable into the hollow housing;
a battery removably affixable to the battery drawer such that when the battery drawer is inserted into the hollow housing the battery is in in electrical communication with the battery receiver and the transducer;
a repellant drawer removably insertable into the hollow housing;
a repellant element impregnated with an evaporating repellant and removably affixable to the repellant drawer such that when the repellant drawer is inserted into the hollow housing the repellant element is adjacent the second vents;
wherein energization of the transducer by the battery causes the transducer to emit high frequency waves though the first vents and air currents cause the repellant to disperse through the second vents.

2. The device of claim 1 further comprising a fastener for securement to a person, wherein when the device is secured against the person and the repellant drawer is inserted into the housing, the repellant element moves with the person and air currents caused thereby causes the repellant to disperse through the second vents.

3. The device of claim 2 wherein the fastener is from the group comprising a strap, a clip, and a strap-clip combination.

4. The device of claim 3 wherein the energized transducer emits high frequency waves at one or more frequencies from the group comprising 7.9 Khz, 12 Khz, 15 Khz, and 17 Khz.

5. The device of claim 4 wherein the printed circuit board further comprises a switch in electrical communication with the battery and the transducer, adapted for energizing the transducer in a closed state and preserving the battery's life in an open state.

6. The device of claim 5 wherein the switch's closed state comprises a plurality of frequency states for selecting the high frequency waves from the group comprising 7.9 Khz, 12 Khz, 15 Khz, and 17 Khz.

7. The device of claim 6 wherein the repellant comprises citronella.

8. The device of claim 7 wherein the battery receiver comprises a spring, and the spring secures the printed circuit board within the hollow housing.

9. A device for repelling pests, comprising:
a strap securable to a person; and
a module comprising;
a hollow housing having first and second vents;
a clip for securement of the hollow housing to the strap;
a printed circuit board disposed within the hollow housing and comprising a battery receiver and a transducer disposed adjacent the first vents;
a battery drawer removably insertable into the hollow housing;
a battery removably affixable to the battery drawer such that when the battery drawer is inserted into the hollow housing the battery is in in electrical communication with the battery receiver and the transducer;
a repellant drawer removably insertable into the hollow housing;
a repellant element impregnated with a evaporating repellant and removably affixable to the repellant drawer such that when the repellant drawer is inserted into the hollow housing the repellant element is adjacent the second vents;
wherein energization of the transducer by the battery causes the transducer to emit high frequency waves though the first vents and air currents cause the repellant to disperse through the second vents; and
when the hollow housing is secured to the strap, the strap is secured to the person and the repellant drawer is inserted into the housing, the repellant element moves with the person and air currents caused thereby causes the repellant to disperse through the second vents.

10. The device of claim 9 wherein the energized transducer emits high frequency waves at one or more frequencies from the group comprising 7.9 Khz, 12 Khz, 15 Khz, and 17 Khz.

11. The device of claim 10 wherein the printed circuit board further comprises a switch in electrical communication with the battery and the transducer, adapted for energizing the transducer in a closed state and preserving the battery's life in an open state.

12. The device of claim 11 wherein the switch's closed state comprises a plurality of frequency states for selecting the high frequency waves from the group comprising 7.9 Khz, 12 Khz, 15 Khz, and 17 Khz.

13. The device of claim 12 wherein the repellant comprises citronella.

14. The device of claim 13 wherein the battery receiver comprises a spring, and the spring secures the printed circuit board within the hollow housing.
